(19) United States
(12) Patent Application Publication
(10) Pub. No.: US 2004/0135303 A1
(43) Pub. Date: Jul. 15, 2004

(54) Folder

(76) Inventor: Gerd Weiler, Kerzenheim (DE)

Correspondence Address: Douglas R Hanscom, Jones Tullar & Cooper, Eads Station, PO Box 2266, Arlington, VA, 22202, US

(21) Appl. No.: 10/472,751

(22) PCT Filed: Mar. 7, 2002
(86) PCT No.: PCT/DE02/00829

(30) Foreign Application Priority Data
Apr. 2, 2001 (DE) 101 16 346.0

(51) Int. Cl. B41F 13/58

(52) U.S. Cl. 270/5.02

(57) ABSTRACT

A folder includes a cutter for cutting a web of material into signatures, a folding device for producing at least one fold in a signature cut from the web of material, at least one delivery device and one conveyor path for directly feeding the cut signatures to the delivery device while avoiding the folding device. The signatures can be guided either by the conveyor path or through the folding device. A signature switch of the conveyor path distributes the signatures to two flies or paddle wheels that deliver to conveyor belt devices that are arranged in parallel to the rotational axes of the paddle wheels.

The invention relates to a folding apparatus in accordance with the preambles of claims 1, 2 or 17.

Such a folding apparatus is known from WO 97/24284 A2. Such a folding apparatus is arranged, for example, at the outlet of a rotary printing press, for the purpose of cutting an imprinted, possibly longitudinally folded web of material, which can consist of one or several layers, into sections, called signatures, and for cutting these signatures once or several times.

In contrast to the printing process, the folding process requires, in particular in the course of transferring the signature from the folding blade cylinder to the folding jaw cylinder, movements of the signature transversely to its surface, which are hampered by the flow resistance of the air. For this reason, during a continuous folding process in which the freshly imprinted web of material is directly feed to a folding apparatus, the maximum operating speed of the folding apparatus is the one factor which limits the processing speed of the entire production process. A further speed-limiting factor results from the fact that the cylinders of the folding apparatus with their folding blades and folding jaws have a multitude of elements which need to be abruptly accelerated and braked during the operation and are therefore subject to wear, which increases superproportionally with increasing processing speed.

In order to increase the flexibility of a folding apparatus, which is a part of a continuous production process, and in particular to make possible the production of items with a differing number of folds, it is known to equip the cylinders of a folding apparatus with grippers, which make possible the guiding of the signatures through the apparatus without folding. However, since these grippers also perform a discontinuous movement, they also limit the processing speed of the printing process even if no fold is being created in the folding apparatus. Moreover, these grippers increase the number of elements subject to wear, which therefore require maintenance.

DE 195 26 169 A1, DE 195 09 947 A1 and DE 36 26 287 A1 each describe a folding apparatus to which an additional module can be laterally connected. This additional module has a feeding track with a paddle wheel and a belt delivery for conveying signatures which were not transversely folded.

EP 0 451 573 A1 discloses a folding unit with a conveying track, wherein a signature shunt is provided for the selective conveyance of the signatures to two delivery devices. A retardation device for slowing down the signatures is arranged between the signature shunt and the delivery devices.

DE 12 04 689 B shows a folding apparatus with a conveying track for conveying signatures to a paddle wheel and a conveyor belt device for carrying off signatures, wherein the removal direction of the conveyor belt device extends parallel with the axis of rotation of the paddle wheel.

A folding apparatus with a conveyor track is known from EP 0 005 822 A1, wherein a signature shunt is arranged upstream of two delivery devices. Each of the delivery devices has a paddle wheel, whose axis of rotations extend transversely in respect to the conveying direction of the conveying track.

DE 196 10 900 A1 discloses a folding apparatus with a cutting device, a folding device for transverse folding, a conveying track and at least one delivery device. Two longitudinal formers are arranged upstream of this folding apparatus, wherein a web path leads to the folding device from a longitudinal former, a web path from the other longitudinal former leads to the conveying track.

The object of the invention is based on producing a folding apparatus.

In accordance with the invention, this object is attained by means of the characteristics of claims 1, 2, 3 or 17.

The advantages to be gained by means of the invention lie in particular in that, because of the possibility provided by the conveying track of moving the signatures past the folding device, the speed-restricting effect of the folding device on the entire printing process is omitted when no fold is required in the finished product.

Another speed-restricting effect can result from a limited processing speed of a paddle wheel of a connected delivery device. If a finished product is tossed at too high a speed into the compartments of such a paddle wheel and is sharply braked by this, damages can result. However, slowing the products prior to their insertion into the paddle wheel is not, or only in a limited way, possible when the products are fed to the paddle wheel in a practically gap-free flow, or with only short distances between them. This problem can be overcome in that a signature shunt for in particular to make possible the production of items with a differing number of folds, it is known to equip the cylinders of a folding apparatus with grippers, which make possible the guiding of the signatures through the apparatus without folding. However, since these grippers also perform a discontinuous movement, they also limit the processing speed of the printing process even if no fold is being created in the folding apparatus. Moreover, these grippers increase the number of elements subject to wear, which therefore require maintenance.

DE 195 26 169 A1, DE 195 09 947 A1 and DE 36 26 287 A1 each describe a folding apparatus to which an additional module can be laterally connected. This additional module has a feeding track with a paddle wheel and a belt delivery for conveying signatures which were not transversely folded.

The object of the invention is based on producing a folding apparatus.

In accordance with the invention, this object is attained by means of the characteristics of claims 1, 2, 3 or 17.

The advantages to be gained by means of the invention lie in particular in that, because of the possibility provided by the conveying track of moving the signatures past the folding device, the speed-restricting effect of the folding device on the entire printing process is omitted when no fold is required in the finished product.

Another speed-restricting effect can result from a limited processing speed of a paddle wheel of a connected delivery device. If a finished product is tossed at too high a speed into the compartments of such a paddle wheel and is sharply braked by this, damages can result. However, slowing the products prior to their insertion into the paddle wheel is not, or only in a limited way, possible when the products are fed to the paddle wheel in a practically gap-free flow, or with only short distances between them. This problem can be overcome in that a signature shunt for the selective feeding of the signatures to at least two delivery devices is provided in the conveying track. If each one of these delivery devices is provided by the signature shunt only with every second, produced signature, each individual delivery device can operate at a speed corresponding to half the production rate of the signatures. The distribution of the signature flow to more than two delivery devices permits an increase of the processing speed which is respectively proportional to the number of the delivery devices.

A speed-retarding device arranged between the signature shunt and each delivery device can reduce the speed of the signatures up to one half, compared with the track speed at the inlet to the folding apparatus.

In accordance with a particularly preferred embodiment, the delivery device(s) in the conveying track is/are equipped with conveyor belt devices, each of which conveys parallel with the axis of rotation of the paddle wheel. This construction causes a change of the movement direction of the signatures by 90° when being deposited on the conveyor belt device, so that trimming of the signatures on all sides becomes possible without corner stations being required for this, which are expensive and limit the processing speed.

Increased flexibility during processing can be achieved in that the folding apparatus has two inlets for the individual or simultaneous feeding of partial webs of material, and means for bringing these partial webs of material together to form the web of material to be processed in the folding apparatus. In this way, in the folding apparatus it is possible to process selectively one web of material alone, which was introduced through the first inlet, one web of material alone, which was introduced through the second inlet, or a web of material composed of partial webs of material introduced through both inlets.

Preferably each one of the inlets is provided with a former for being able to create a longitudinal fold in the partial web of material introduced through this inlet.

A further increase of flexibility is achieved by means for separating the two partial webs of material again; which make it possible to feed a first partial web of material to the conveying track, and a second partial web of material to the folding device. In this way both processing units of the folding apparatus, the conveying track and the folding device, can be fully utilized simultaneously.

It is worth noticing that the conveying track and the folding device of the folding apparatus defined above can each be used for producing identical products, i.e. the conveying track and the folding device can be simultaneously operated, and in this way again increase the processing speed. For this purpose, a longitudinal cutting device for cutting a web of material into a first and a second partial web of material is usefully placed upstream of the folding apparatus, wherein the first partial web of material has twice the width of the second one and is fed to the folding device longitudinally folded. By conveying this first partial web of material over the conveying track and cutting it there into signatures of a defined length, while the second partial web of material in the folding device is cut into signatures of twice the length and then transversely folded, it is possible to create respectively identical products on the conveying track and the folding device at great speed.

A particularly compact low construction can be achieved in that the two delivery devices have paddle wheels which rotate in opposite directions and deliver to oppositely running conveyor belt devices. These conveyor belt devices can be conducted out of the apparatus on different sides, but at the same height. It is furthermore advantageous for a compact construction if the component, which comprises the conveying track and deliver devices assigned to it, has an inlet and a first outlet for the first delivery device in a first end section, and in the oppositely located end area has an outlet for the second delivery device, wherein the paddle wheel of the first delivery device is substantially arranged in the center of the component. Such an arrangement allows the positioning of the component substantially congruent above or below a folding device, so that the requirement for placement space is not increased in comparison with a conventional folding apparatus.

An exemplary embodiment of the invention is represented in the drawings and will be described in greater detail in what follows.

Shown are in:

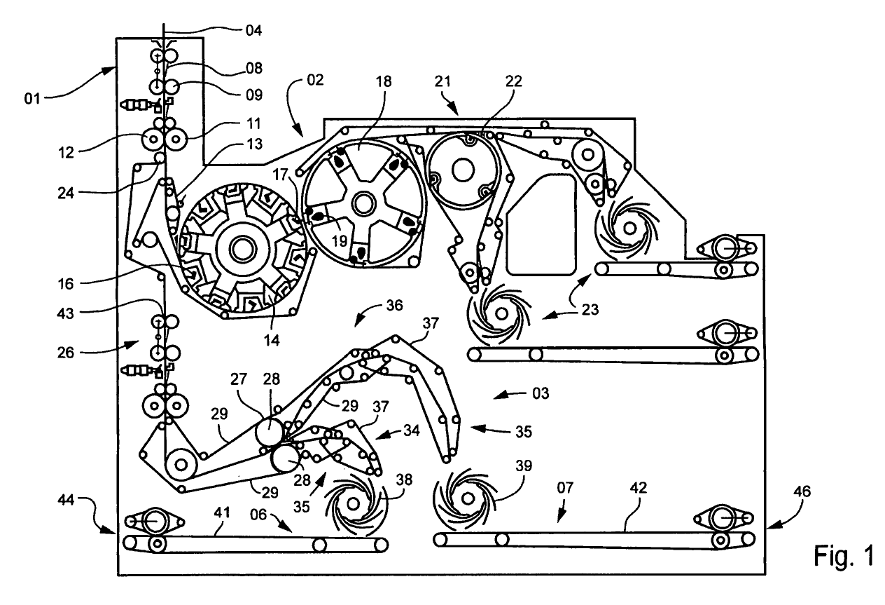

FIG. 1, a schematic cross section through a folding apparatus,

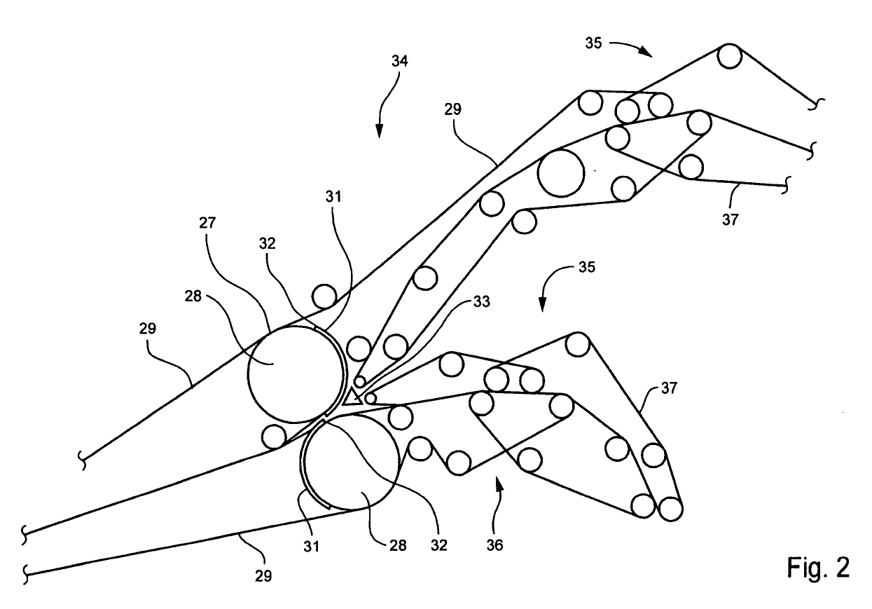

FIG. 2, an enlarged portion of FIG. 1,

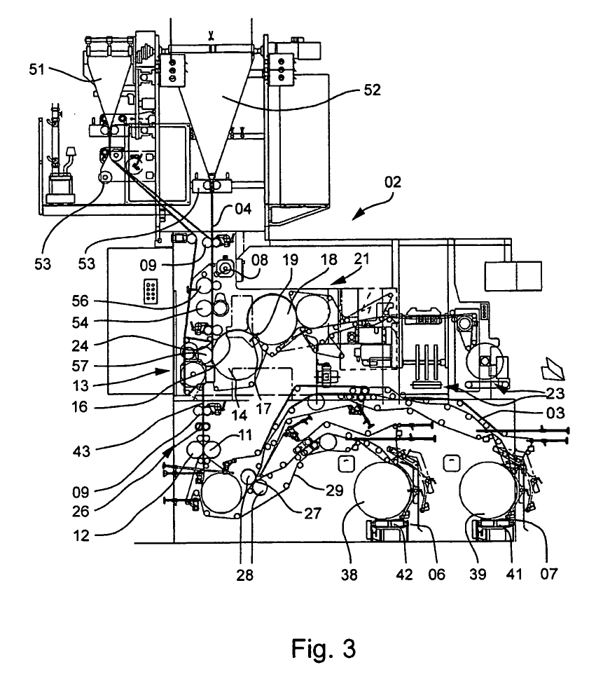

FIG. 3, a schematic cross section through a folding apparatus in accordance with a second embodiment.

The folding apparatus represented in FIG. 1 is substantially comprised of three functional groups, a cutting device 01 for cutting a material web 04, which has been introduced into the apparatus and is possibly longitudinally folded, a folding device 02 for folding the cut-to-size signatures, and a conveying track 03, on which signatures are conveyed directly to delivery devices 06, 07 while bypassing the folding device 02.

The cutting device 01 comprises a rotating cutter 08 for longitudinally trimming the web of material 04, a traction roller 09 for maintaining a preset tension in the web of material 04, and following this, blade and groove cylinders 11, or 12, which cut off a signature from the incoming web of material 04 with each rotation. The diameters of the blade cylinder 11 and groove cylinder 12 are adjustable for adapting the cutting device 01 to the processing of signatures of various lengths.

The severed signatures are guided to a folding blade cylinder 14 by a first conveyor belt device 13, wherein the speed of the conveyor belt device 13 is matched to the relative phase position between the blade cylinder 11 and the groove cylinder 12, or the folding blade cylinder 14, in such a way that a leading edge of each signature encounters a gripper 16 of the folding blade cylinder 14 and is clamped by it. The signature is conveyed to a gap between the folding blade cylinder 14 and a folding jaw cylinder 18 with the aid of the grippers 16. In this gap, folding blades 17 of the folding blade cylinder 14 are flipped out for pressing the signature into a folding jaw 19 of the folding jaw cylinder 18. The signature is transferred to the folding jaw cylinder 18 by being clamped into the folding jaw 19. It is passed on by the latter to a second conveyor belt device 21, which distributes the flow of signatures to two delivery devices 23 via a signature shunt 22.

With the embodiment of the invention represented in FIG. 1, the cutting device 01 can be inactivated, for example by moving the blade cylinder 11, or groove cylinder 12 away from the web of material 04. In the conveying direction downstream of the blade cylinder 11 and groove cylinder 12 there is a branch 24, by which the web of material 04 can be conveyed around the first conveyor belt device 13 to a second cutting device 26. The construction of this cutting device 26 is analog to that of the cutting device 01 and will therefore not be described again.

The conveying track 03 follows the cutting device 26. It receives signatures cut by the cutting device 26 and initially conveys them to a signature shunt 27. The signature shunt 27 is comprised of two rollers 28 placed opposite each other, around each of which belts 29 of the conveyor belt device 03 are looped, and each of which has cams 31 which protrude up to half of their circumference and which can be more clearly seen in the enlarged representation of FIG. 2.

The conveying speed of the conveying track 03 in the area of the rollers 28, or the track speed of the belts 29, is selected in such a way that the distance between each of the leading edges 32 of the cams 31 corresponds to the distance between the leading edges 32 of signatures conveyed on the conveying track 03 in the area of the belts 29. The cams 31 control a back-and-forth movement between two positions of a wedge 33 arranged in the outlet nip of the gap between the two rollers 28, in which positions it guides the signatures passing through the gap into respectively one of two conveying conduits 34, 36.

In a first section, the conveying conduits 34, 36 are defined by belts 29 which are looped around the rollers 28, and whose track speeds accordingly correspond to the circumferential speed of the rollers 28. A retardation device 35 is formed in a second section of each of the conveying conduits 34 or 36 by belts 37, which move at a lesser speed and slow the signatures down. The retardation devices 35 can also have several sections, constituted by belts 37 with successively reduced speeds for the stepped slowing of the signatures.

The conveying conduits 34, 36 each lead to a paddle wheel 38, or 39, into whose paddles the conveyed signatures fall. The left paddle wheel 38 assigned to the conveying conduit 34 rotates in a clockwise direction and makes deposits on a conveyor belt 41 running toward the left; the right paddle wheel 39 rotates in a counterclockwise direction and makes deposits on a conveyor belt 42 running toward the right. The speeds of the paddle wheels 38 or 39 and of the conveyor belts 41 or 42 are each matched to each other in such a way that, in the area where the deposited signatures touch the conveyor belt 41 or 42, the circumferential speed of the paddle wheel 38, 39 substantially corresponds to the conveying speed of the conveyor belt. Thus, the deposit of the signatures on the conveyor belt 41, 42 is not caused by a traction force of the conveyor belt 41, 42 on the signatures, but exclusively by the pushing of a deposit arm which is arranged, fixed in place, on the paddle wheels 38, 39 and enters into a gap between the paddles so that, when the paddles rotate past the deposit arm, the latter pushes the signatures out of the paddles. In this way an absolutely dependable and evenly fish-scaled deposit of the signatures is achieved, even at a high operating speed of the paddle wheels 38, 39.

The conveying track 03 and the cutting device 26 assigned to it form a modular component, which can be installed underneath a conventional folding apparatus with slight adaptations of the latter, such as the subsequent attachment of the branch 24, without additional placement space being required for this. This becomes possible in particular because of the asymmetric construction of the module. The signatures pass through a conventional folding apparatus in a direction from left to right in respect to FIG. 1. The modular component is matched to this in that the inlet 43 for the material to be processed, in this case the inlet of the second cutting device 26, is arranged in a first end area of the component (the left end area in FIG. 1), and that both paddle wheels 38, 39 are located offset in relation to this inlet 43 in the direction toward the other end area (toward the right in FIG. 2). Thus, in the same way as with the folding apparatus, no placement space is required to the left of the inlet 43. Moreover, the oppositely rotating arrangement of the two paddle wheels 38, 39 allows the removal of the products in two directions via outlets 44, 46 on one level, so that only little structural height is required.

In principle, a space-saving arrangement would also be conceivable, wherein the component of the conveying track 03 is mounted above that of the folding device 02. However, the above described arrangement, represented in FIG. 1, is preferred, because the folding device 02, which requires a greater maintenance and adjustment outlay than the conveying track 02, is more easily accessible.

In the embodiment here described, its own cutting device 26 has been arranged upstream of the conveying track 03 in order to achieve simple retrofitting of an existing folding apparatus by means of the conveying track 03 and the two delivery devices 06, 07.

It is of course also possible to integrate the two functions of the folding apparatus, cutting and folding, more closely with each other in that only one cutting device is provided and a signature shunt is provided at the outlet of this cutting device, which allows it to convey the cut signatures selectively to the folding device or the conveying track.

Whenever the conveying device 03 is operating, the folding device 02 can be completely shut off. For one, this leads to a reduced power consumption of the folding apparatus, and wear of the sensitive parts of the folding apparatus is also reduced as well, furthermore, the folding apparatus can be operated at a higher speed than would be possible if the folding device 02 were operated.

FIG. 3 shows a cross section of a folding device, analogous to FIG. 1, of a second embodiment of the invention. Elements, whose structure and function correspond to the elements already described in relation with FIGS. 1 and 2, have the same reference symbols.

This folding apparatus has two inlets in the form of two formers 51, 52. The web of material 04 to be processed can be supplied selectively via one of these two formers 51, 52, however, it can also only be created inside the folding apparatus in that partial webs of material, simultaneously conveyed via the two formers 51, 52 are deflected by means of rollers 53 and are placed on top of each other to form the web of material 04.

Subsequently the web of material 04 passes over a traction roller 09 and a cutter 08 for longitudinal trimming. Transverse and longitudinal perforating units 54, 56 for the transverse and longitudinal perforation of the web of material 04 are arranged following the cutter 08 and upstream of a second traction roller 09.

There are two paths along which the web of material 04 can be further conveyed after the second traction roller 09, toward the folding device 02 or the conveying track 03. If the web of material 04 is composed of two partial webs respectively fed through the two formers 51, 52, both partial webs can respectively be conveyed either to the folding device 02 or the conveying track 03, or the web of material 04 can again be divided into the partial webs and the partial web supplied via the former 51 is further conveyed to the conveying track 03, the partial web supplied via the former 52, however, is conveyed to the folding device 02.

In this case, the inlet of the folding device 02 is constituted by a gap between a blade cylinder 57 and the folding blade cylinder 14. On its inlet 34, the conveying track 03 has, as already described in respect to FIG. 1, a second cutting device 26 for dividing the supplied web of material into signatures. The length of these signatures is not necessarily the same as that of the ones cut by the blade cylinder 27, in particular, they can be half as long or less than the latter. The structure of the conveying track following the cutting device 26 corresponds to a great extent to the one described in connection with FIGS. 1 and 2. However, a first difference is that in the embodiment of FIG. 3 the paddle wheels 38, 39 rotate in the same direction. A second important difference is that the conveyor belts 41, 42 on which the paddle wheels 38, 39 deposit, are oriented in a direction parallel with the axis of rotation of the paddle wheels 38, 39, i.e. they convey in a direction perpendicular in relation to the plane of the drawing FIG. 3. The conveying direction is the same for both conveyor belts 41, 42 and has been selected in such a way that the created signatures, to the extent they have a longitudinal fold created in the folding cylinder 51 or 52, are conveyed out with the longitudinal fold at the front.

By means of the change of the conveying direction of the signatures out of the plane in FIG. 3 in a direction perpendicular in respect to this plane, it is possible with the aid of cutters, not represented in the drawing, to trim the tops and bottoms of the signatures conveyed out on the conveying belts 41, 42, without corner stations being required for this, in which the signatures are respectively slowed down and turned by 90° for aligning their trimmed edges in the conveying direction.

As can be seen, the folding apparatus in FIG. 3 also permits the processing of a fed-in web of material into a multitude of different product formats. However, a particularity of this folding apparatus is the possibility of producing identical products by means of the simultaneous operation of the folding device 02 and the conveyor track 03 via respectively different intermediate steps, and in this way to achieve a very high processing speed for these products. To make use of this particularity, a web of material, such as an imprinted paper web, is cut into three partial webs whose widths are identical with each other in a longitudinal cutting apparatus, known per se and therefore not represented here, which is arranged upstream of the folding apparatus. Two partial webs are conveyed on top of each other to the folding apparatus via the former 51, forming a longitudinal fold, the other partial web is conveyed without a longitudinal fold via the former 52. At the level of the second traction roller 09 the two partial webs are separated again, the wider partial web without a longitudinal fold is conveyed to the folding device 02, is cut into signatures of a defined length and the signatures are folded once transversely, and longitudinally in the third fold in order to obtain a product of half the length of the signatures. But the two partial webs on top of each other are conveyed to the conveying track 03, at whose inlet they are directly cut into signatures of the said half length. The signatures obtained in this way are distributed by means of the signature shunt 27 to the two conveyor belts 41, 42. In this way the folding apparatus produces three signatures in each work cycle of the folding device 02.

At least two longitudinal formers 51, 52 are arranged upstream of the folding apparatus. A first web path is provided from the one longitudinal former 52 to the folding device 02, and a second web path from the other longitudinal former 51 to the conveying track. The second web path runs independently of the first web path.

### List of Reference Symbols

01 Cutting device, first

02 Folding device

03 Conveying track

04 Web of material

05 -

06 Delivery device

07 Delivery device

08 Cutter

09 Traction roller

010 -

011 Blade cylinder

012 Groove cylinder

013 Conveyor belt device, first

014 Folding blade cylinder

015 -

016 Gripper

017 Folding blade

018 Folding jaw cylinder

019 Folding jaw

020 -

021 Conveyor belt device, second

022 Signature shunt

023 Delivery device

024 Branch

025 -

026 Cutting device, second

027 Signature shunt

028 Roller

029 Belt

030 -

031 Cam

032 Edge, leading

033 Wedge

034 Conveying conduit

035 Retardation device

036 Conveying conduit

037 Belt

038 Paddle wheel

039 Paddle wheel

040 -

041 Conveyor belt

042 Conveyor belt

043 Inlet

044 Outlet

045 -

046 Outlet

047 -

048 -

049 -

050 -

051 Former

052 Former

053 Roller

054 Transverse perforating unit

055 Longitudinal perforating unit

056 Blade cylinder

1. A folding apparatus, having a cutting device (01, 26), a folding device (02) for transverse folding, and at least one delivery device (06, 07, 23), wherein the folding apparatus has a conveying track (03) for the direct conveyance of cut signatures to a delivery device (06, 07), while bypassing the folding device (02), and the signatures can be selectively guided over the conveying track (03) and/or through the folding device (02), characterized in that the conveying track (03) has a signature shunt (27) for the selective conveying of the signatures to at least two delivery devices (06, 07), and at least one retardation device (35) for slowing the signatures is arranged between the signature shunt (27) and each delivery device (06, 07).

2. A folding apparatus, having a a cutting device (01, 26), a folding device (02) for transverse folding, and at least one delivery device (06, 07, 23), wherein the folding apparatus has a conveying track (03) for the direct conveyance of cut signatures to a delivery device (06, 07), while bypassing the folding device (02), and the signatures can be selectively guided over the conveying track (03) and/or through the folding device (02), characterized in that the conveying track (03) has a signature shunt (27) for the selective conveying of the signatures to at least two delivery devices (06, 07), and that the delivery device (06, 07, 26) of the conveying track (03) respectively has a paddle wheel (38, 39) and a conveyor belt device (41, 42), which conveys parallel with the axis of rotation of the paddle wheel (38, 39).

3. A folding apparatus with at least one paddle wheel (38, 39), with at leasat one conveying track (03) for conveying signatures to the paddle wheel (38, 39), and at least one conveyor belt devie (41, 42) for moving signatures away, wherein the removal conveying direction of the conveyor belt device (41, 42) is arranged to extend parallel in respect to the axis of rotation of the paddle wheel (38, 39), characterized in that feeding direction of the conveying track (03) is arranged transversely to the axis of rotation of the paddle wheel (38, 39).

4. The folding apparatus in accordance with claim 2, characterized in that at least their own delivery device (23, 06, 07) is respectively assigned to the folding device (02) and the conveying track (03).

5. The folding apparatus in accordance with claim 4, characterized in that the conveying track (03) has a signature shunt (27) for the selective feeding of signatures to at least two delivery devices (06, 07).

6. The folding apparatus in accordance with claims 2 or 5, characterized in that at least one retardation device (35) for slowing the signatures is arranged between the signature shunt (27) and each delivery device (06, 07).

7. The folding apparatus in accordance with claim 5, characterized in that the two delivery devices (06, 07) have paddle wheels (38, 39) which rotate in opposite directions for delivering to two oppositely running conveyor belt devices (41, 42).

8. The folding apparatus in accordance with claims 1 or 3, characterized in that every delivery device (06, 07, 26) of the conveying track (03) respectively has a paddle wheel (38, 39) and a conveyor belt device (41, 42), which conveys parallel with the axis of rotation of the paddle wheel (38, 39).

9. The folding apparatus in accordance with claims 1, 2 or 3, characterized in that the conveying track (03) and the delivery device(s) assigned to it form a modular component.

10. The folding apparatus in accordance with claim 9, characterized in that the component is arranged underneath the folding device (02).

11. The folding apparatus in accordance with one of the preceding claims, characterized in that it has two inlets for the individual or simultaneous introduction of partial webs of material into the folding apparatus, and means for bringing together the partial webs of material to form a web of material (04).

12. The folding apparatus in accordance with claim 11, characterized in that at least one of the inlets is equipped with a former (51, 52).

13. The folding apparatus in accordance with claim 11 or 12, characterized in that it has means for separating the two partial webs of material again and for conveying a first partial web of material to the conveying track (03), and the second partial web of material to the folding device (02).

14. The folding apparatus in accordance with claim 13, characterized in that a longitudinal cutting device for cutting apart a web of material (04) into the first and the second partial web of material is arranged upstream of it.

15. The folding apparatus in accordance with one of the preceding claims, characterized in that a cutting device (01, 26) is respectively assigned to the folding device (02) and the conveying track (03).

16. The folding apparatus in accordance with one of the preceding claims, characterized in that the folding device (02) can be switched off when the signatures are conveyed over the conveying track (03), or the conveying track (03) is switched off when the signatures are fed to the folding device (02).

17. The folding apparatus in accordance with claim 2, characterized in that cutters, which trim the edges of the signatures arranged in the conveying direction, are assigned to the conveyor belt device (41, 42).

18. A method for using a folding apparatus, having a cutting device (01, 26), a folding device (02) for transverse folding, a conveying track (03) and at least one delivery device (06, 07, 23), wherein at least two longitudinal formers (51, 52) are arranged upstream of the folding apparatus, wherein a first web path is provided from the one longitudinal former (52) to the folding device (02), wherein a second web path, which runs independently of the first web path, is provided from the other longitudinal former (51) to the conveying track (03), characterized in that in the course of the simultaneous operation of the folding device (02) and the conveying track (03) identical products are produced over respectively different intermediate steps.

19. The method in accordance with claim 18, characterized in that a web of material is cut into three partial webs, that two partial webs are fed one above the other to the folding apparatus via a former (51) while a longitudinal fold is made, that the other partial web is feed via the former (52) without a longitudinal fold, that the partial web without a longitudinal fold is fed to the folding device (02), is cut into signatures and these signatures are folded once transversely and in the third fold are folded longitudinally, that the two partial webs lying above each other are fed to the conveying track (03) and are cut into signatures of half length.
